(19) United States
(12) Patent Application Publication
(10) Pub. No.: US 2011/0240535 A1
(43) Pub. Date: Oct. 6, 2011

(54) SYSTEM FOR CONTROLLING FLUID LEVELS IN A WASTEWATER TREATMENT BIOLOGICAL REACTOR

(76) Inventors: Richard L. Pehrson, Efland, NC (US); Wayne J. Flournoy, Chapel Hill, NC (US)

(21) Appl. No.: 12/752,658

(22) Filed: Apr. 1, 2010

(51) Int. Cl. C02F 3/12

(52) U.S. Cl. 210/104; 210/232; 210/97

(57) ABSTRACT

A system for controlling at least one prescribed fluid level in a biological reactor for treating wastewater or portion thereof, the system comprising at least one effluent assembly having an effluent screen; at least one sensor configured for monitoring a fluid level; at least one sparge apparatus configured for providing matter in a prescribed manner to the at least one effluent assembly; at least one matter source configured for providing matter; at least one control point configured for regulating said matter movement; and at least one controller. A kit comprising at least a controller and a sensor. A regulatory system configured for regulating the system.

The present invention is directed towards a physical system for controlling at least one prescribed fluid level in a biological reactor for treating wastewater or portion thereof, a computer system for accomplishing the same, and a kit for assembling the components appropriate for controlling at least one prescribed fluid level in an existing biological reactor or portion thereof.

### BACKGROUND OF THE INVENTION

Wastewater treatment is driven by the desire to renovate wastewater before it re-enters a body of water, is applied to the land, is reused, or any combination of the preceding to prevent pollution of lakes, rivers, and/or streams. An abundance of organics, which act as food for a growth biology, and/or an abundance of nutrients, which feed microorganisms or growth biology, in soil, lakes, rivers, and/or streams will support growth biology. The growth biology is then able to consume available oxygen to, in effect, suffocate wildlife normally found in the lakes, rivers, and/or streams. Wastewater treatment seeks to reduce this food (organics) and/or these nutrients prior to the water being discharged such that the available oxygen in lakes, rivers, and/or streams will be at levels that support wildlife. Also, wastewater treatment seeks to disinfect (usually with chlorine, UV or ozone) to prevent the spread of human pathogens (typically virus and bacteria).

### SUMMARY

Aspects of embodiments and embodiments of the present invention provide, without limitation, a system for regulating the prescribed fluid level in a biological reactor of a wastewater treatment facility or portion thereof.

Aspects of embodiments and embodiments of the present invention meet these and other needs by providing, without limitation, (a) a system for controlling at least one prescribed fluid level within a portion of a biological reactor and/or a biological reactor, (b) regulation system for regulating the flow of matter to at least one sparge apparatus in a portion of a biological reactor and/or a biological reactor, (c) a kit configured for use at a wastewater treatment facility including a portion of a biological reactor and/or a biological reactor, (d) associated processes, (e) associated machines, and/or (f) associated manufactures. The system may include at least one of any one of an effluent assembly, a sensor, a sparge apparatus, a matter source, a control point, and a controller. The regulation system may include at least one of any one of a sensor component and a controller component. The kit may include at least one of any one of a conduit, control point, and an effluent assembly.

In some aspects of embodiments and embodiments relating to (a) through (f), the at least one effluent assembly may be configured to substantially determine the at least one prescribed fluid level. To that end, the at least one effluent assembly may include an effluent screen configured to permit the passage of effluent from a portion of the biological reactor and/or the biological reactor. Examples of effluent screen, without limitation, include a wedgewire screen, a round wire screen, a perforated mesh screen, an expanded metal screen, or any combination thereof. Additionally or alternatively, such effluent screen may be configured for substantial exclusion of one or more media and passage of effluent from a portion of the biological reactor and/or the biological reactor and through the effluent screen.

In some aspects of embodiments and embodiments to (a) through (f), the biological reactor, without limitation, includes any one of a tank, basin, lagoon, or any combination of the preceding. Such enumerated items, without limitation, may be found at any one of a municipal wastewater treatment facility, an industrial wastewater treatment facility, a commercial wastewater treatment facility, a ship wastewater treatment facility, an agricultural wastewater treatment facility, or any combination thereof.

In some aspects of embodiments and embodiments to (a) through (f), of the system may further include one or more media configured to support growth biology. Examples of one or more media, without limitation, may include one or more media configured for substantial exclusion of the one or more media by an effluent screen a while at the same time permitting the passage of the effluent from a portion of the biological reactor and/or the biological reactor and through the effluent screen.

In some aspects of embodiments and embodiments relating to (a) through (f), the at least one sensor may be configured to monitor a fluid level within a portion of the biological reactor and/or the biological reactor. Examples of the at least one sensor, without limitation, include any one of a float sensor, ultrasonic sensor, a differential pressure sensor, a capacitance sensor, other fluid level sensing devices or any combination thereof. In some aspects, monitored fluid level data may be communicated to the at least one controller.

The functions of the various elements of the at least one sensor discussed above would, in aspects of embodiments and/or embodiments, be implemented by one or more elements either alone or in combination with one or more programmed processors, one or more digital signal processing (DSP) chips, or the like rather than individual hardware elements. Thus, in the claims hereof any element expressed as a means for performing a specified function is intended to encompass any way of performing that function including, for example:
(a) a combination of electrical elements which perform that function, or
(b) a combination of mechanical elements which perform that function, or
(c) a combination of optical elements which perform that function, or
(d) a combination of magnetic elements which perform that function, or
(e) software in any form (including, therefore, firmware, microcode or the like) combined with appropriate circuitry for executing that software to perform the function, or
(f) a combination of elements from any one of (a) through (e) which perform that function.
   Thus it will be appreciated that applicants regard any elements capable of performing particular functions recited in the claims as being equivalent to those disclosed herein.

In some aspects of embodiments and embodiments relating to (a) through (f), the at least one sparge apparatus may be configured for providing matter in a prescribed manner to the at least one effluent assembly. An example of the at least one sparge apparatus, without limitation, includes a bubble generator, such as, without limitation, any one of a large bubble generator, a fine bubble generator, or any combination thereof. Examples of the location of the sparge apparatus, without limitation, include (i) in-line with and below the effluent assembly, (ii) inside the effluent assembly, or (iii) combinations thereof. In other aspects of embodiments and embodiments, the at least one sparge apparatus system may further include any one of: (iv) at least one conduit configured for a movement of matter therethrough; (v) at least one opening configured for a movement of matter therethrough and release therefrom; (vi) the at least one conduit configured for communication with the at least one matter source; and/or, (vii) the at least one opening is located on said conduit.

In any of the forgoing two aspects of embodiments and embodiments, the at least one opening may be configured to direct the matter in any one direction in 360° of the at least one conduit. Additionally or alternatively, a distance between the at least one opening and the at least one effluent assembly may be between about zero and about three-quarters of the depth of a portion of a biological reactor and/or a biological reactor. Additionally, at least one additional opening may be configured to direct the matter in a direction different from the direction that the at least one opening directs the matter.

In some aspects of embodiments and embodiments relating to (a) through (f), the at least one matter source may be configured for providing matter to be communicated to the at least one sparge apparatus. Examples of forms of matter that the at least one matter source may be configured to provide, without limitation, include any one of a gas, a liquid, a foam, or any combination thereof. Examples of a gas, without limitation, include any one of atmospheric air, methane, nitrogen, one or more commercially available gasses, or any combination thereof. Examples of a liquid, without limitation, include a fluid from a portion of the biological reactor and/or the biological reactor.

In some aspects of embodiments and embodiments relating to (a) through (f), the at least one control point may be configured for regulating a movement of matter to the sparge apparatus. Examples of the at least control point, without limitation, include any one of a valve, pump, or any combination thereof. For example, the control point may be, without limitation, a solenoid valve, gate valve, needle valve, ball valve, butterfly valve, or any combination thereof.

In some aspects of embodiments and embodiments relating to (a) through (f), the at least one controller may be configured to communicate with any one of the at least one sensor, the at least one sparge apparatus, the at least one matter source, the at least one control point, or any combination thereof. To that end, in an aspect, the at least one controller may be configured to communicate with the at least one sensor and the at least one control point. In another aspect, the at least one controller may be configured to regulate a movement of matter to the at least one sparge apparatus at predetermined times. In yet another aspect, the at least one controller may be configured to regulate the movement of matter to the at least one sparge apparatus when the at least one controller receives a predetermined value or parameter value from the at least one sensor. In an additional or alternative example, the at least one controller may be configured to incrementally regulate the movement of matter to the at least one sparge apparatus when said controller receives a predetermined parameter from said at least one sensor and/or at predetermined times. In another additional or alternative example, the at least one controller may be configured to regulate the movement of matter to the at least one control point when the at least one controller receives predetermined parameters from said at least one sensor by and/or at predetermined times. Such regulated movement of matter, without limitation, may occur by any one of causing the at least one control point to (i) either fully constrict or fully release, (ii) either incrementally constrict or incrementally restrict, or (iii) any combination thereof. Examples of the at least controller, without limitation, include any one of a mechanical controller, a manually operated controller, a programmable logic controller, an electromechanical controller, an electronic controller, a pneumatic controller, or any combination of any of the preceding.

Accordingly, some aspects of embodiments and embodiments of present invention provide a system for controlling at least one prescribed fluid level within a portion of a biological reactor and/or a biological reactor, each configured for treating wastewater. The system may include at least one of any one of an effluent assembly, a sensor, a sparge apparatus, a matter source, a control point, and a controller. The at least one effluent assembly is configured to substantially determine the at least one prescribed fluid level. To that end, the at least one effluent assembly may include an effluent screen configured to permit the passage of effluent from a portion of the biological reactor and/or the biological reactor. The at least one sensor may be configured to monitor a fluid level within a portion of the biological reactor and/or the biological reactor. The at least one sparge apparatus may be configured for providing matter in a prescribed manner to the at least one effluent assembly. The at least one matter source may be configured for providing matter to be communicated to the at least one sparge apparatus. The at least one control point may be configured for regulating a movement of matter to the sparge apparatus. The at least one controller may be configured to communicate with any one of the at least one sensor, the at least one sparge apparatus, the at least one matter source, the at least one control point, or any combination thereof.

Other aspects of embodiments and embodiments of present invention provide a regulation system for regulating the flow of matter to at least one sparge apparatus in a portion of a biological reactor and/or a biological reactor, each configured for treating wastewater. The regulation system may include at least one of any one of a sensor component and a controller component. The at least one sensor component may be configured to measure a fluid level in a portion of the biological reactor and/or the biological reactor. The at least one controller component may be configured to compare the measured fluid level to predetermined value and/or value ranges and then may be configured to accordingly regulate the flow of matter to at least one sparge apparatus.

Still other aspects of embodiments and embodiments of present invention provide a kit configured for use at a wastewater treatment facility including a portion of a biological reactor and/or a biological reactor. The kit may include at least one of any one of a conduit, control point, and an effluent assembly. The at least one conduit may include at least one opening. The at least one opening may be configured to be capable of being arranged to direct matter in any one pre-selected direction. Also, the at least one conduit may be configured to be capable of being affixed (a) in-line and below the at least one effluent assembly, (b) inside of the at least one effluent assembly, or (c) any combination thereof. The least one control point may be configured to be capable of being arranged so as to be in communication with the at least one conduit. The at least one effluent assembly may include at least one effluent screen. Also, the at least one effluent assembly may be configured to be capable of being associated with an effluent penetration point.

Numerous other aspects of embodiments, embodiments, features, and advantages of the present invention will appear from the following detailed description and the accompanying drawings. In the description and/or the accompanying drawings, reference is made to exemplary aspects of embodiments and/or embodiments of the invention which can be applied individually or combined in any way with each other. Such aspects of embodiments and/or embodiments do not represent the full scope of the invention. Reference should therefore be made to the claims herein for interpreting the full scope of the invention. In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5. Also in the interest of brevity and conciseness, it is to be understood that such terms as “is,” “are,” “includes,” “having,” “comprises,” and the like are words of convenience and are not to be construed as limiting terms and yet may encompass the terms “comprises,” “consists essentially of,” “consists of,” and the like as is appropriate.

These and other aspects, advantages, and salient features of the present invention will become apparent from the following detailed description, the accompanying drawings, and the appended claims.

### BRIEF DESCRIPTION OF THE FIGURES

FIG. 1 is a diagram illustrating a system according to aspects of embodiments of the invention.

FIG. 2 is a diagram illustrating a system according to aspects of embodiments of the invention.

FIG. 3 is a perspective view of aspects of embodiments of the present invention.

FIG. 4 is a diagram illustrating a kit according to aspects of embodiments of the present invention.

FIG. 5 is a perspective view of aspects of embodiments of the present invention.

FIG. 6 is a perspective view aspects of embodiments of the present invention.

FIG. 7A is a perspective view of aspects of embodiments of the present invention.

FIG. 7B is a perspective view of aspects of embodiments of the present invention.

FIG. 7C is a perspective view of aspects of embodiments of the present invention.

FIG. 8A is a decision diagram describing the operation of a computer system according to an aspect of the present invention.

FIG. 8B is a decision diagram describing the operation of a computer system according to an aspect of the present invention.

FIG. 8C is a decision diagram describing the operation of a computer system according to an aspect of the present invention.

### DETAILED DESCRIPTION OF THE INVENTION

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

While typical aspects of embodiment and/or embodiments have been set forth for the purpose of illustration, the foregoing description and the accompanying drawings should not be deemed to be a limitation on the scope of the invention. Accordingly, various modifications, adaptations, and alternatives may occur to one skilled in the art without departing from the spirit and scope of the present invention. It should be understood that all such modifications and improvements have been deleted herein for the sake of conciseness and readability but are properly within the scope of aspects of embodiments of the present invention. Numerous other aspects of embodiments, embodiments, features, and advantages of the present invention will appear from the description and the accompanying drawings. In the description and/or the accompanying drawings, reference is made to exemplary aspects of embodiments and/or embodiments of the invention, which can be applied individually or combined in any way with each other.

The present invention is a system for regulating the fluid level in a biological reactor or portion thereof. Applicants contemplates that the present invention may be used with any biological reactor or portion thereof found within a wastewater treatment system. Wastewater treatment systems include, but are not limited to, municipal wastewater treatment facilities, industrial wastewater treatment facilities, commercial wastewater treatment facilities, ship wastewater treatment facilities, agricultural wastewater treatment facilities, or any combination of any of the preceding. A biological reactor may be any one of a tank, a basin, a lagoon, or any combination of any of the preceding. Also, a biological reactor may be any one of covered, uncovered, aerated, not aerated; have natural mixing, induced mixing, or any combination of any of the preceding.

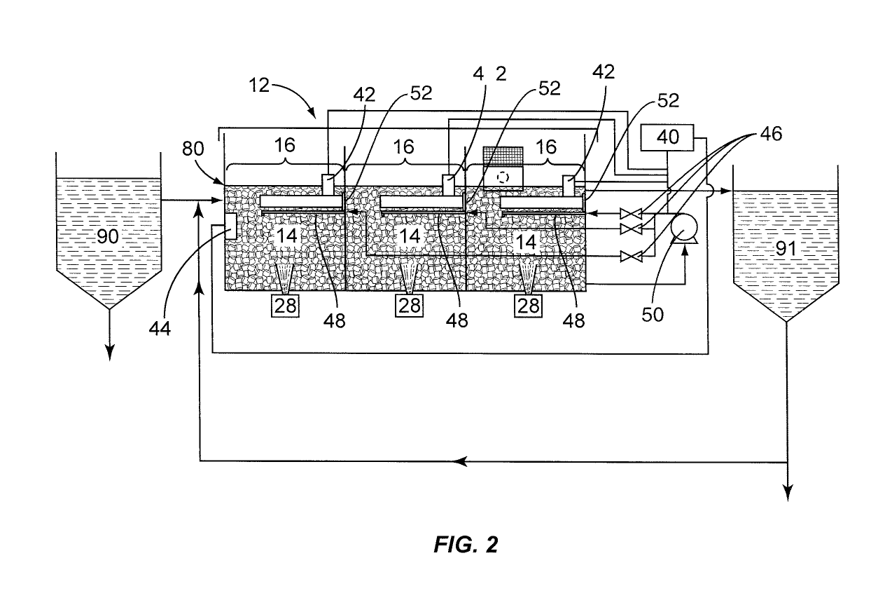

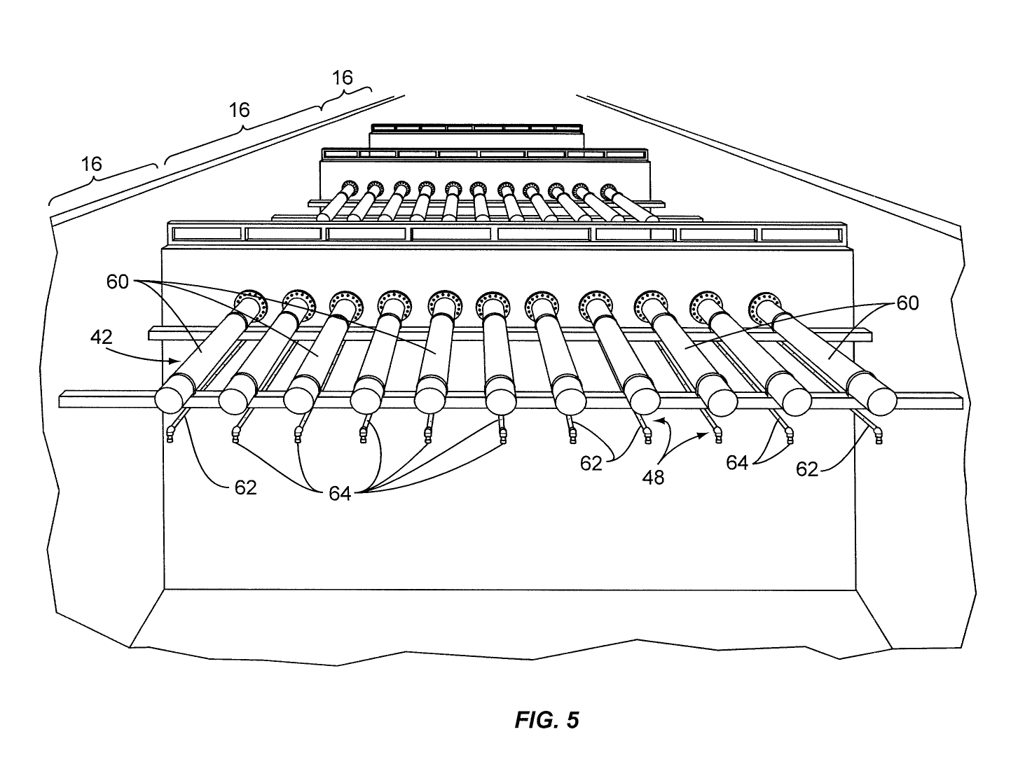

Turning now to the Figures. As shown in FIGS. 2 and 5, it is contemplated that a biological reactor 12 may be partitioned into portions 16 by one or more controlled reaction volume module(s), one or more stages, or any other means for separating an area of the biological reactor 12 from the remainder of the biological reactor 12. Controlled reaction volume modules may be placed, positioned, or supported in a biological reactor 12 by a variety of mechanisms including any one of floats, side of reactor attachments/supports, bottom of reactor attachments/supports, or any combination of any of the preceding. Stages may be created by a variety of mechanisms including any one of walls, screens, pumps, or any combination of any of the preceding.

It is contemplated that the effluent or fluid within the biological reactor 12 or portions 16 thereof will flow into the biological reactor 12 or portions 16 thereof from one area, such as 90, and flow out of the biological reactor 12 or portions 16 thereof into another area, such as 91, into the biological reactor 12 or portions 16 thereof, or into an area such as 90 where the effluent will then flow into the biological reactor 12 or portions 16 thereof.

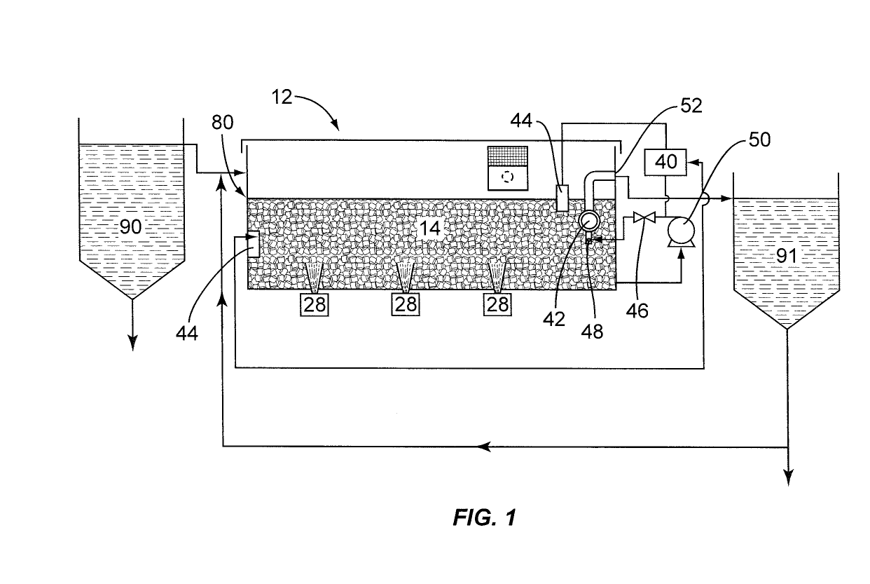

Biological reactors 12 or portions 16 thereof may include a number of media 14 as shown in FIGS. 1 and 2. Biological reactors 12 or portions 16 thereof may additionally include mixing devices 28. Mixing devices 28 facilitate the mixing and/or aeration within a biological reactor 12 or portion 16 thereof with or without additional mixing and/or operation functionality from other components found within the biological reactor 12 or portion 16 thereof. The mixing devices 28 may be individual units or multiple units and may be manifolded-together systems that may incorporate control valving to allow for controlled operation on an independent or group basis. Examples of such mixing devices 28 include, but are not limited to, mechanical mixers, air diffusers, gas phase mixers, or any combination thereof.

The system may be controlled by a controller 40. Examples of a suitable controller 40 include, but are not limited to, any one of a mechanical controller, a controller operated manually, an electromechanical controller, an electronic controller, a pneumatic controller, programmable logic controllers (PLCs), time controllers, or any combination of any of the preceding. A controller 40 may be integrated into a main and/or sub plant controller with or without a local panel. In this manner, an integration of the control of the operation of a biological reactor 12 or portions 16 thereof into the main and/or sub plant controller may be accomplished.

The system may include an effluent assembly 42 which substantially determines the fluid level of the biological reactor 12 or portion 16 thereof. The effluent assembly 42 may be associated with an effluent penetration point 52 such that the effluent or fluid within the biological reactor 12 or portion 16 thereof exits through the effluent penetration point 52 via the effluent assembly 42. The movement of effluent through the effluent assembly 42 and the effluent penetration point 52 substantially determines the level of the fluid in the biological reactor 12 or portion 16 thereof (the “fluid level” 80).

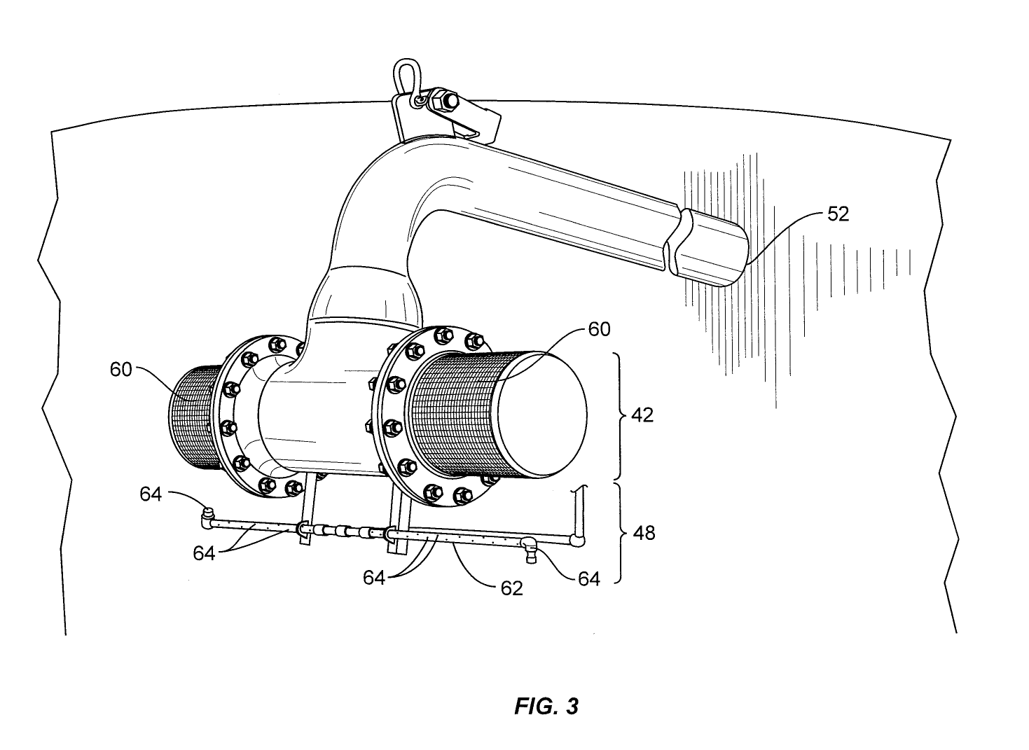

The fluid level 80 may rise or fall depending on many different factors within the wastewater treatment system operator's control, such as pumping, and outside his or her control, such as rain. Generally, the operator will prefer the fluid level 80 to be at or about a certain level, the prescribed level, for various reasons such as efficiency. The prescribed level can be a range and/or can change depending on the needs or desires of the operator and/or the wastewater treatment system. The effluent assembly 42 comprises at least one effluent screen 60 as shown in FIGS. 3, 4, 5, 6, 7A, 7B and 7C sized so as to facilitate retention of the number of media 14 within the biological reactor 12 or portion 16 thereof and/or to impede the movement of solids with the effluent through the effluent penetration point 52. Such effluent screen 60 may be sized with openings smaller than the smallest dimension of a media 14 or other such size as appropriate to impede the movement of solids through the effluent penetration point 52 with the effluent. For example, an opening of the screen may be about two-thirds of the smallest dimension of a media 14.

The Applicants contemplate that examples of such effluent screens 60 include, without limitation, grating, expanded metal, hexagonal netting, perforated mesh screen, square mesh, wedgewire screen, welded wire mesh, wire mesh fence, woven, other screens known to one having ordinary skill in the art upon consideration of the present teachings, or any combination thereof. Such effluent screens 60 may be made of any type of material adapted to withstand a wastewater treatment system, specifically an anaerobic, anoxic, oxic, aerobic, or any combination of systems, wastewater treatment system, without degrading and/or corroding substantially. Examples include, but are not limited to, metallic materials such as stainless steels, durimet alloys, titanium, titanium alloys, carbon steel, aluminum, or other metals known to one skilled in the art upon consideration of the present teachings; polymers including without limitation, polyvinyls such as polyvinyl chloride, polyolefins such as polyethylene and/or polypropylene, fluoropolymers such as polyvinylidene fluoride or polytetrafluoroethylene (PTFE), polyester, or other polymers known to one skilled in the art upon consideration of the present teachings; other materials adapted to withstand a wastewater treatment system, specifically an anaerobic, anoxic, aerobic, or any combination of systems wastewater treatment system, without degrading and/or corroding substantially known to one skilled in the art upon consideration of the present teachings; a composite of at least two of the preceding; or any combination of any of the preceding.

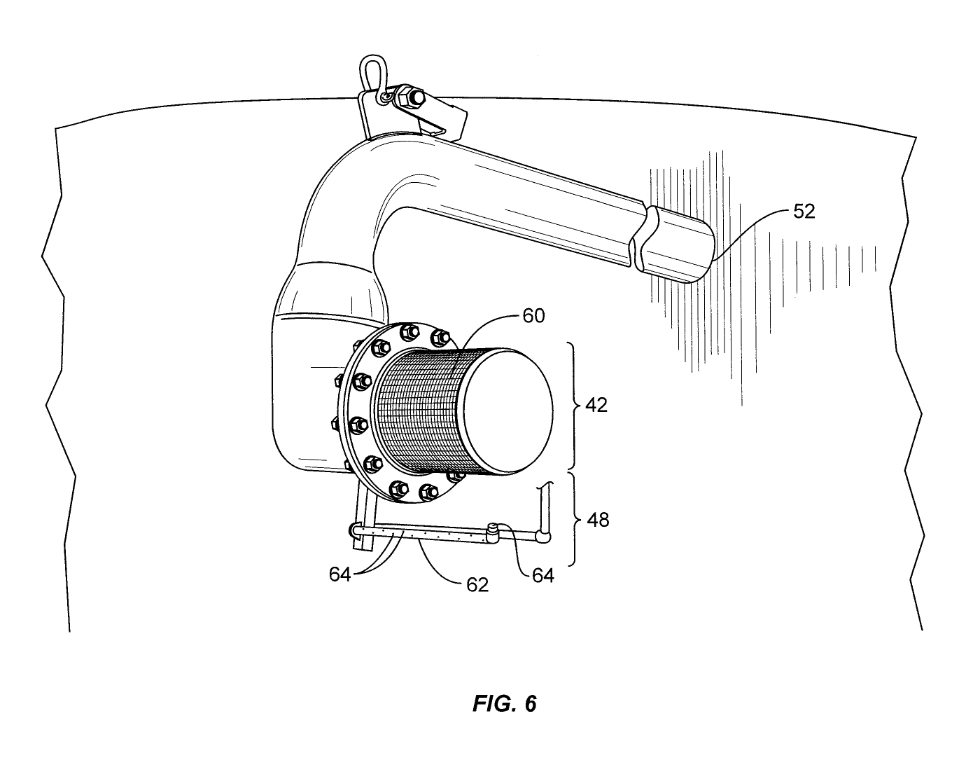

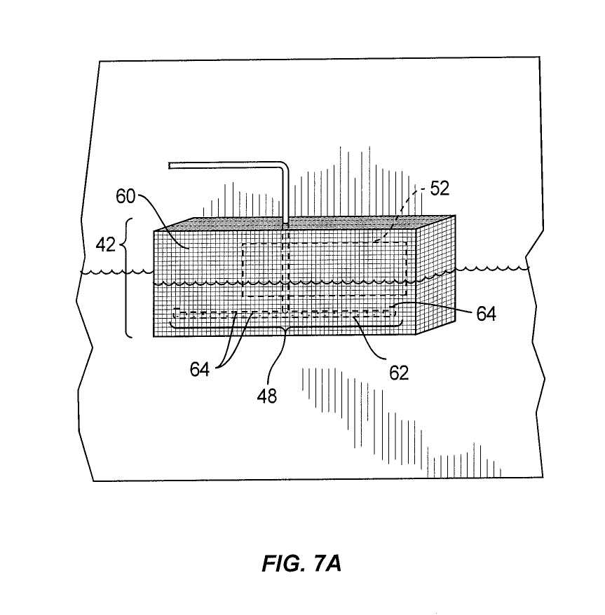

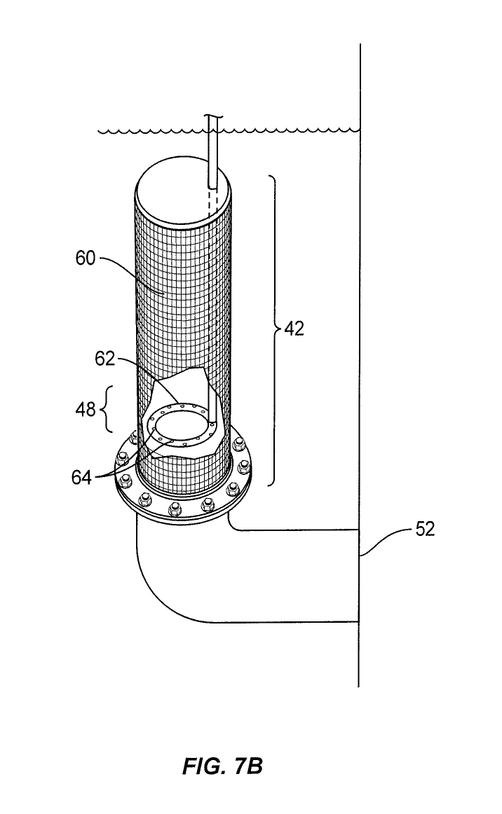

The effluent assembly 42 may be formed in many different configurations including, but not limited to, T-assemblies in which the effluent screens 60 extend perpendicular to that portion of the effluent assembly 42 associated with an effluent penetration point 52 as seen in FIG. 3, L-assemblies in which the effluent screens 60 extend perpendicularly in one direction from that portion of the effluent assembly 42 associated with an effluent penetration point 52 as seen in FIG. 6, horizontal assemblies in which the effluent screens 60 are associated horizontally with an effluent penetration point 52 as seen in FIGS. 2, 5, and 7C, vertical-up assemblies in which the effluent screens 60 are associated parallely with and extend parallel to an effluent penetration point 52 towards the top of the biological reactor 12 or portion 16 thereof, as seen in FIG. 7B, vertical-down assemblies in which the effluent screens 60 are associated parallely with and extend parallel to an effluent penetration point 52 towards the bottom of the biological reactor 12 or portion 16 thereof (not shown), box assemblies in which the effluent screens 60 are associated with an effluent penetration point 52 to form a box which encloses or partially encloses an effluent penetration point 52 as seen in FIG. 7A, any of the above configurations where the effluent screens 60 further have an inclination angle of less than 90° or less than or greater than 180° dependent on the original orientation of the effluent screens 60, such as horizontal) (180° in the case of the T-assemblies, L-assemblies, horizontal assemblies, and vertical) (90° such as the vertical-up assemblies, vertical-down assemblies, and the like, or any combination of the preceding.

The system also may include a sparge apparatus 48. The sparge apparatus 48 may be a bubble generator such as, but not limited to, a large bubble generator, a fine bubble generator, or any combination thereof. A bubble generator breaks a given volume of matter, for example, gas, liquid, or foam, into bubbles sized according to the surface tension of the orifices, baffles, perforations, or other structures known to one having ordinary skill in the art upon consideration of the present teachings, through which the matter passes. The bubble sizes are generally categorized as “large,” sometimes termed “coarse;” or “small,” sometimes termed “fine,” depending on the diameter of the bubbles. The largest diameter bubbles are “large” or “coarse” and the smallest diameter bubbles are “small” or “fine.” Generally, small or fine bubbles have a diameter less than or about 5 mm while large or coarse bubbles have a diameter greater than or about 5 mm. (U.S. Pat. No. 4,639,314).

The sparge apparatus 48 may include a conduit 62 through which matter, for example, gas, liquid, or foam, moves. The conduit 62 may be in communication with a matter source 50 from or through which matter flows to the conduit 62. The conduit 62 may be any fixture through which matter may move, including, but not limited to, tubing, piping, or other such structure to direct the movement of matter from the matter source 50 to and through the sparge apparatus 48. It is contemplated that the conduit 62 may be any geometric shape. It is further contemplated that the conduit 62 may be produced from any material which would not interfere with the movement of the matter and/or be adapted to withstand a wastewater treatment system without degrading and/or corroding substantially. Examples of such materials include, but are not limited to, metallic materials such as stainless steels, durimet alloys, titanium, titanium alloys, carbon steel, aluminum, or other metals known to one skilled in the art upon consideration of the present teachings; polymers including without limitation, polyvinyls such as polyvinyl chloride, polyolefins such as polyethylene and/or polypropylene, fluoropolymers such as polyvinylidene fluoride or polytetrafluoroethylene (PTFE), polyester, or other polymers known to one skilled in the art upon consideration of the present teachings; any other material adapted to withstand a wastewater treatment system, specifically an anaerobic, anoxic, aerobic, or any combination of systems wastewater treatment system, without degrading and/or corroding substantially known to one skilled in the art upon consideration of the present teachings; a composite of at least two of the preceding; or any combination of any of the preceding.

An opening 64 or a series of openings 64 may be located on the conduit 62. The matter may pass or be released through such openings 64. The openings 64 may be located on the conduit 62 in such a manner that the matter being released may be released in any direction within 360° of the conduit 62. A series of openings 64 may be located on the conduit 62 in such a manner that the matter is released in directions different from one another on the same conduit 62. The location of the opening 64 or openings 64 in relation to the effluent assembly 42 may be anywhere between about three-quarters (¾) of the depth of the biological reactor 12 or portion 16 thereof and directly adjacent to the effluent screen 60 or any portion of the effluent assembly 42. In one aspect of an embodiment of the current invention, the opening 64 at the farthest point on the conduit 62 in one direction may be larger than the preceding openings 64 to allow any media 14, effluent, or other material caught in the conduit 62 to be discharged.

In an aspect of an embodiment of the current invention as shown in FIG. 3, the sparge apparatus 48 may be located in-line with the effluent assembly 42 and below the effluent assembly 42. In an aspect of an embodiment of the current invention as shown in FIGS. 7A, 7B, and 7C, the sparge apparatus 48 may be located inside the effluent assembly 42 such that any media 14 or other solid material is contained on the opposite side of the effluent screen 60 from the effluent penetration point 52. In an aspect of an embodiment of the current invention, the sparge apparatus 48 may comprise sections located both inside the effluent assembly 42 and outside the effluent assembly 42 (not shown). In an aspect of an embodiment of the current invention as shown in FIGS. 7A, 7B, and 7C, the sparge apparatus 48 may be located outside the effluent assembly 42 (not shown). In the above aspects, the position of the sparge apparatus 48 in relation to the effluent assembly 42 may be such that a significant portion of the matter being released from the opening 64 or openings 64 of the sparge apparatus 48 will make contact with the effluent screen 60.

The system may include a matter source 50. The matter source 50 may be any device or structure for the holding and/or regulating of the matter used in the system. Matter found in the matter source 50 may be in a liquid or gas phase, in a phase transition between liquid and gas, in the form of foam, or any combination thereof. The matter may be lighter than the fluid in the biological reactor 12 or portion 16 thereof or have other characteristics which allow the matter to move towards the surface of the biological reactor 12 or portion 16 thereof once released from the opening 64 or openings 64. Examples of gas matter include, but are not limited to, atmospheric air, methane, nitrogen, commercially available gasses, or any combination thereof. Such gasses may be carbon dioxide, oxygen, any gas known to one having ordinary skill in the art upon consideration of the present teachings or combinations thereof. Examples of liquid matter include, but are not limited to, effluent from the biologic reactor 12 or portion 16 thereof, any fluid known to one having ordinary skill in the art, upon consideration of the present teachings, which would move towards the surface of the biological reactor 12 or portion 16 thereof once released from the openings 64, or any combination thereof.

The system may include a control point 46. The control point 46 may be constricted or released to allow different volumes of the matter to move through the control point 46. For example, a fully constricted control point 46 will not allow any matter to move past the control point 46 while a fully released control point 46 will allow the amount of matter that can pass through the control point 46 to pass through the control point 46. It is contemplated that the control point 46 may be a device that can either constrict and release fully or can constrict and release incrementally between and including full constriction and full release. Examples of control point 46 devices include, but are not limited to, valves such as solenoid, gate, needle, ball, and butterfly valves; pumps; other devices known to one having skill in the art upon consideration of the present teachings; and combinations thereof.

The system may include one or more sensors 44. It is contemplated the sensor 44 or sensors 44 will recognize the fluid level 80 at the point of the sensor 44 location. Many different types of sensors 44 may be suitable for this task. Examples of suitable sensors 44 include, but are not limited to, float sensors, ultrasonic sensors, differential pressure sensors, capacitance sensors, and other fluid level sensors being mechanically or electrically connected to the controller 40. It is contemplated that the sensors 44 may additionally monitor other characteristics of the fluid or effluent. Sensors 44 may monitor growth biology, nutrients and/or nutrient concentration, organics, other characteristics know to one having skill in the art upon consideration of the present teachings, or combinations of any of the preceding. The sensors 44 may communicate the fluid level 80 data and/or some other data associated with the fluid to the controller 40.

In a wastewater treatment system there is a possibility that the effluent screens 60 through which the effluent passes may become blocked by either the media 14 located in the biological reactor 12 or portion 16 thereof, growth biology or microorganisms, or other impediments to the flow of the effluent. When or how this blockage occurs is not predictable. The present invention uses a system of a controller 40 regulating the fluid level 80 to compensate for possible blockage of the effluent screens 60. The current system may regulate the fluid level 80 by regulating a control point 46, the control point 46 being connected to at least one sparge apparatus 48, wherein the control point 46 regulates either gradually or fully the movement of the matter from a matter source 50 through the control point 46 to the sparge apparatus 48. The matter in the form of liquid, foam, gas or any combination thereof may then be released through the openings 64 located in proximity to the effluent screen 60 or portion of the effluent assembly 42 such that a portion of the matter makes contact with a portion of the effluent assembly 42. It is contemplated that a series of sparge apparatuses 48 may be connected to a controller 40. It is further contemplated that each effluent assembly 42 may be associated with a sparge apparatus 48 though there may be systems where the effluent assemblies 42 are selectively associated with a sparge apparatus 48 such that every effluent assembly 42 is not associated with a sparge apparatus 48. The controller 40 may be connected to all sparge apparatuses 48 in the biological reactor 12 or portions 16 thereof or to pre-selected sparge apparatuses 48 located in the biological reactor 12 or portions 16 thereof. The regulation of the control point 46 may be triggered by a variety of different sensors 44 within the biological reactor 12 or portion 16 thereof. When the sensor 44 communicates a predetermined parameter or range of parameters, the controller 40 may open or close the control point 46 as described above; may regulate the flow of matter from the matter source 50; may regulate the flow of matter through the sparge apparatus 42 via the conduit 62, the openings 64, or a combination thereof; or may act on the system in some other way to regulate the matter movement to or through the sparge apparatus 42. It is contemplated that there may be at least one controller 40, effluent assembly 42, and sparge apparatus 48 in every biological reactor 12 or portion 16 thereof. It is also contemplated that the controller 40 may be connected to all of the sparge apparatuses 48 in a biological reactor 12 or portion 16 thereof or only to pre-selected sparge apparatuses 48 located in the biological reactor 12 or portion 16 thereof. It is contemplated that the controller 40 may control the control point 46 as described above in such a manner that matter only moves to pre-selected, individual sparge apparatuses 48, pairs of sparge apparatuses 48, sets of sparge apparatuses 48, or combinations of sparge apparatuses 48. However, the number and placement of sparge apparatuses 48 may be determined by the wastewater treatment system operator.

In an aspect of an embodiment of the current invention as shown in FIG. 1, a controller 40, in conjunction with a sparge apparatus 48, effluent apparatus 42, sensor 44, and control point 46, is configured to regulate the fluid level 80. The controller 40 may communicate with the sparge apparatus 48, the control point 46, sensors 44, effluent assembly 42, or any combination thereof to regulate the fluid level 80. The controller 40 may be in communication with at least one sensor 44 and at least one control point 46 to regulate the fluid level 80. The controller 40 may be in communication with a matter source 50 and at least one sensor 44 to regulate the fluid level 80.

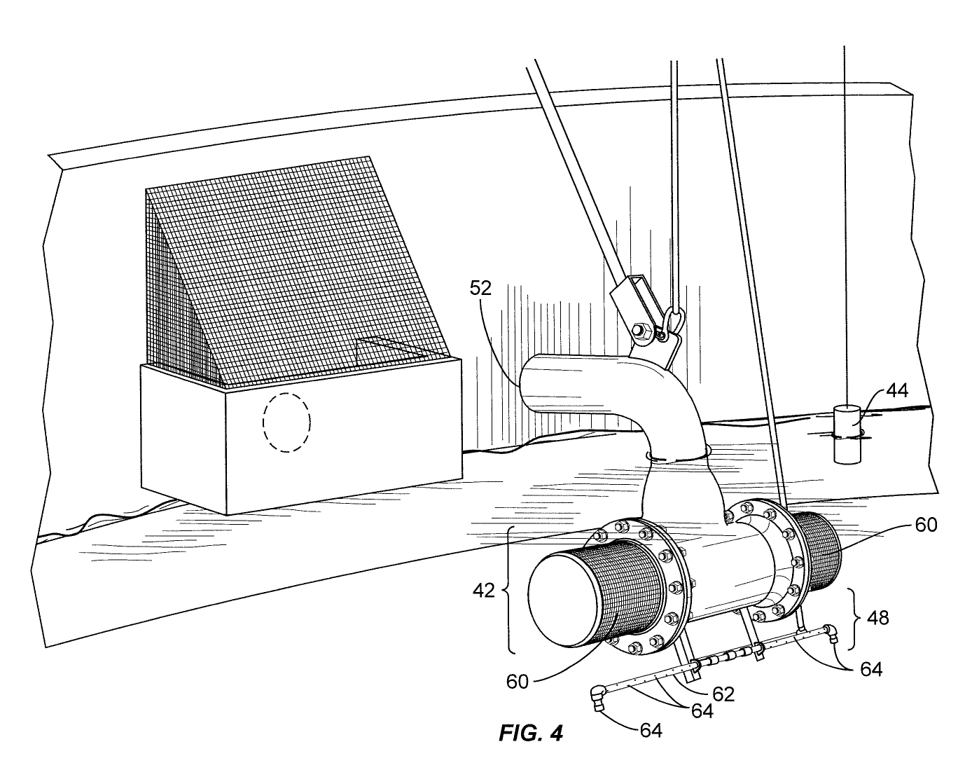

In another embodiment of the invention, the sparge apparatus 48, and sensor 44, including all appropriate connectors as shown in FIG. 4, and controller 40 (not shown), are fitted to a current waste water treatment system. In such an embodiment, the controller 40 may be integrated into the main and/or sub plant controller, may be an individual unit not integrated into the main and/or sub plant controller, may be a series of controllers of which one or more are integrated into the main and/or sub plant controller and one or more are not integrated into the main and/or sub plant controller, or any combination thereof.

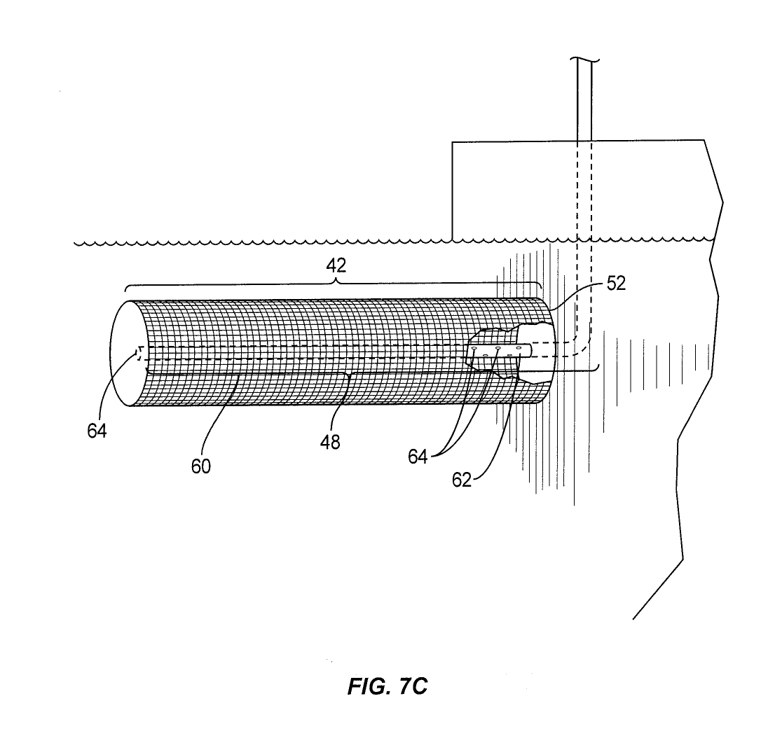

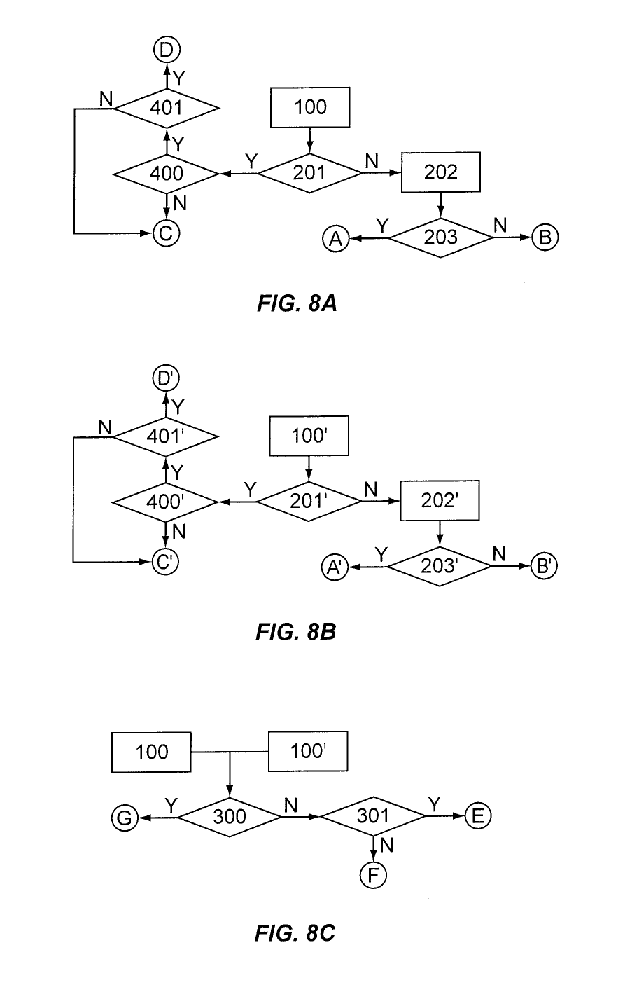

In another embodiment of the invention, the controller 40 compares fluid level 80 data from a sensor 44 or from a group of sensors 44 to predetermined data points. The controller 40 may open, close, partially open, or partially close the control point 46 or series of control points 46 according to the result of the comparison of the received fluid level 80 data and the predetermined data points. The process is presented schematically in FIGS. 8A, 8B, and 8C.

Turning now to FIGS. 8A, 8B, and 8C. FIG. 8A depicts a computer program schematic for regulating the movement of matter through the system. At point 100, the controller 40 receives the fluid level 80 data from the sensor 44. The controller 40 then compares the fluid level 80 data to predetermined data points at point 201. If the data is within the predetermined data point range (a “Yes” determination), the controller 40 determines at point 400 whether the control point 46 is open (a “Yes” determination). If the control point 46 is open, the controller 44 determines at point 401 if the control point 46 is fully open. If the control point 46 is fully open, the controller 40 partially closes the control point 46 at point D. If the control point 46 is not fully open, or if the control point 46 is not open at all, the controller 40 orders the control point 46 to close or to stay closed as the case may be at point C. If the fluid level 80 data is not within the predetermined range at point 201, the controller 40 may determine whether the fluid level 80 data is within a larger or smaller predetermined data range at point 202. At point 203, the controller 40 may open the control point 46 completely, or open the control point 46 incrementally, depicted by points A and B respectively depending on whether the fluid level 80 data is within a larger, or smaller, or different predetermined data range. It is contemplated that the controller 40 may only have one predetermined data range, in which case the controller 40 may be programmed to either open the control point 46 fully or incrementally at point 201 if the fluid level 80 data is not within the predetermined range. It is further contemplated that the controller 40 may have different predetermined data ranges, in which case the controller 40 may be programmed to compare the fluid level 80 data to all the ranges before regulating the control point 46 accordingly. It is further contemplated that the controller 40 may be receiving fluid level 80 data from several different locations within the biological reactor 12 or from different stages or portions 16 of the biological reactor 12 such as individual stages or controlled volume modules. In such an embodiment, the controller 40 may be able to compare the fluid level 80 data amongst the different locations of the biological reactor 12 or portions 16 thereof. It is further contemplated that the controller 40 may be regulating other elements of the system in addition to or instead of the control point 46, such as, but not limited to, the matter source 50 and/or the sparge apparatus 48 in the same manner as the movement of matter is regulated above. As shown in FIG. 8B, a separate controller 40 may be running the same process as depicted in FIG. 8A such that separate sensors 44 are communicating fluid level 80 data to a separate controller 40. In one embodiment of the invention, several different sensors 44 are communicating fluid level 80 data to one controller 40 as depicted in FIG. 8C. At points 100 and 100′, in FIG. 8C, the controller 40 is comparing the fluid level 80 data from separate sensors 44. At point 300, the controller 40 determines whether the difference between the fluid level 80 data communicated by separate sensors 44 is within a predetermined parameter or range of data. The comparison made by the controller 40 may be of the ratio of the fluid level 80 data, a strict comparison of the fluid level 80 data such that the data is not manipulated in any way, a comparison of the fluid level 80 data where the data has been manipulated by different formula manipulating the data as determined by the system operator, any other comparison known to one having a skill in the art upon consideration of the present teachings, or any combination thereof. If the fluid level 80 data comparison is within the predetermined data range, the controller 40 will not regulate the movement of matter. If the fluid level 80 data comparison is outside of the predetermined data range (a “Yes” determination), the controller 40 may determine which fluid level 80 data is higher at point 301. The fluid level 80 data which is higher, or otherwise outside of the predetermined range, will then be the biological reactor 12 or portion 16 thereof, which is acted upon by the controller 40 as indicated by points E and F. In the example depicted in FIG. 8C, at point 301, the controller 40 may determine whether the fluid level 80 data from point 100′ is higher than the fluid level 80 data at point 100. If the fluid level 80 data at point 100′ is higher than the fluid level 80 data at point 100, the controller 40 will regulate the fluid level 80 of the stage from which the data at point 100′ came from, as depicted by point E. If the fluid level 80 from 100′ is not higher, the controller 40 will then act to regulate the fluid level 80 coming from point 100, depicted by F. It is contemplated that in such an embodiment, the program may be such that the comparison of the different fluid level 80 data will take precedent, or otherwise override, the actions of the controller 40 on the biological reactor 12 or portion 16 thereof as depicted in FIGS. 8A and 8B. Applicants contemplate that the program may be such that the actions of the controller 40 as depicted in FIGS. 8A and 8B may take precedent or override, the composition of the different fluid level 80 data as depicted in FIG. 8C.

In another embodiment of the current invention, the controller 40 may be on a timer. The timer may trigger the controller 40 to regulate matter movement at predetermined times. To accomplish this regulation, the controller 40 may open, close, partially open, or partially close the control point 46 or series of control points 46; may regulate the flow of matter from the matter source 50; may regulate the flow of matter through the sparge apparatus 48 via some action on the conduit 62, some action on the openings 64, or a combination thereof; or may act on the system in some other way to regulate the matter movement. It is contemplated that the controller 40 may be on a timer and controlled by a program or programs as described above. It is further contemplated that a system may comprise several controllers 40, some of which are on a timer, others of which are being controlled by a program or programs as described above, and/or others of which are both on a timer and controlled by a program or programs as described above.

Wastewater treatment processes require careful management to ensure the protection of the water body that receives the discharge. Trained and certified treatment plant operators engaged in such management, upon consideration of the present teachings as described above, would have an understanding of how to adapt the invention to different systems such as:

Fixed Film Systems: Fixed film systems grow microorganisms on substrates such as rocks, sand, or plastic. The wastewater is spread over the substrate, allowing the wastewater to flow past the film of microorganisms fixed to the substrate. As organic matter and nutrients are absorbed from the wastewater, the film of microorganisms grows and thickens. Trickling filters, rotating biological contactors, and sand filters are examples of fixed film systems.

Suspended Film Growth Systems: Suspended film growth systems stir and suspend microorganisms in wastewater. As the microorganisms absorb organic matter and nutrients from the wastewater, they grow in size and number. After the microorganisms have been suspended in the wastewater for several hours, they are settled out as sludge. Some of the sludge is pumped back into the incoming wastewater to provide “seed” microorganisms. The remainder is wasted and sent on to a sludge treatment process. Activated sludge, extended aeration, oxidation ditch, and sequential batch reactor systems are all examples of suspended film systems.

Lagoon Systems: Lagoon systems are normally large, relatively shallow basins that hold the wastewater for a few days to several months to allow for the natural degradation of sewage. These systems may be aerated artificially or take advantage of natural aeration and microorganisms in the wastewater to renovate sewage.

Integrated Fixed-Film/Activated Sludge (IFAS) System: IFAS systems combine suspended microorganisms with fixed microorganisms. A media of the present invention may be used as a carrier for the fixed microorganisms' portion of an IFAS systems.

Certain modifications and improvements will occur to those skilled in the art upon a reading of the foregoing description. All such modifications and improvements of the present invention have been deleted herein for the sake of conciseness and readability.

Numerous other aspects of embodiments, embodiments, features, and advantages of the present invention will appear from the description and the accompanying drawings. In the description and/or the accompanying drawings, reference is made to exemplary aspects of embodiments and/or embodiments of the invention, which can be applied individually or combined in any way with each other. Such aspects of embodiments and/or embodiments do not represent the full scope of the invention. Reference should therefore be made to the claims herein for interpreting the full scope of the invention.

What is claimed is:

1. A system for controlling at least one prescribed fluid level in a biological reactor for treating wastewater or portion thereof, the system comprising:
(a) at least one effluent assembly configured to substantially determine the at least one prescribed fluid level and having an effluent screen for permitting the passage of effluent from the biological reactor or portion thereof;
(b) at least one sensor configured to monitor a fluid level within the biological reactor or portion thereof;
(c) at least one sparge apparatus configured to provide matter in a prescribed manner to the at least one effluent assembly;
(d) at least one matter source configured to provide matter to be communicated to the at least one sparge apparatus;
(e) at least one control point configured to regulate said matter movement to said sparge apparatus; and
(f) at least one controller, wherein said controller is configured to be in communication with any one of said at least one sensor, said at least one sparge apparatus, said at least one matter source, said at least one control point, or any combination thereof.

2. The system according to claim 1, further including a media configured to support growth biology.

3. The system according to claim 2, wherein said media configured to support growth biology comprises a plurality of media and wherein the effluent screen is configured to substantially exclude the passage of the plurality of media from the biological reactor or portion thereof.

4. The system according to claim 1, wherein said controller is configured to be in communication with said at least one sensor and said at least one control point.

5. The system according to claim 1, wherein said at least one controller is configured to regulate said matter movement to said at least one sparge apparatus at predetermined times, when a predetermined parameter value is sensed by said at least one sensor, or any combination thereof.

6. The system according to claim 1, wherein said at least one controller is configured to incrementally regulate said matter movement to said at least one sparge apparatus at predetermined times, when a predetermined parameter value is sensed by said at least one sensor, or any combination thereof.

7. The system according to claim 1, wherein said at least one controller is configured to regulate said at least one control point at predetermined times, when a predetermined parameter value is sensed by said at least one sensor, or any combination thereof by:
(a) causing said at least one control point to fully constrict or fully release;
(b) causing said at least one control point to incrementally constrict or incrementally restrict; or
(c) any combination thereof.

8. The system according to claim 1, wherein said at least one sensor is a float sensor, ultrasonic sensor, differential pressure sensor, capacitance sensors, or any combination thereof.

9. The system according to claim 1, wherein said at least one sensor is configured to communicate said fluid level data to said at least one controller.

10. The system according to claim 1, wherein said sparge apparatus is located at any of in-line with said effluent assembly and below said effluent assembly, inside said effluent assembly, outside of at least one effluent assembly or any combination thereof.

11. The system according to claim 1, further comprising said at least one sparge apparatus configured to have:
at least one conduit configured for matter to move through; and
at least one opening configured for matter to move through and from;
wherein said at least one conduit is configured to be in communication with said at least one matter source; and
wherein said at least one opening is located on said conduit.

12. The system according to claim 11, wherein said at least one opening is configured to release said matter in any one direction in 360° of said at least one conduit.

13. The system according to claim 11, wherein said distance between said at least one opening and said at least one effluent assembly is between zero and three-quarters of the depth of the biological reactor or portion thereof.

14. The system according to claim 11, wherein said at least one opening is configured to release said matter in a direction different than at least one other said at least one opening on said at least one sparge apparatus, conduit, or any combination thereof.

15. The system according to claim 1, wherein said at least one matter source is configured to contain matter in gas form, liquid form, foam form, or any combination thereof.

16. The system according to claim 15, wherein said gas comprises atmospheric air, methane, commercially available gasses, or any combination thereof.

17. The system according to claim 15, wherein said gas comprises atmospheric air.

18. The system according to claim 15, wherein said liquid comprises fluid from said biological reactor or portion thereof.

19. The system according to claim 1, wherein said at least one controller comprises any one of a mechanical controller, a controller operated manually, a programmable logic controller, an electromechanical controller, an electronic controller, a pneumatic controller, or any combination of any of the preceding.

20. The system according to claim 1, wherein said control point comprises any one of a valve, pump, or any combination thereof.

21. The system according to claim 20, wherein said valve comprises any one of a solenoid valve, gate valve, needle valve, ball valve, butterfly valve, or any combination thereof.

22. The system according to claim 1, wherein said at least one sparge apparatus is a bubble generator.

23. The system according to claim 22, wherein said bubble generator comprises a large bubble generator, a fine bubble generator, or any combination thereof.

24. The system according to claim 1, wherein said effluent screen is a wedgewire screen, a round wire screen, a perforated mesh screen, an expanded metal screen, or any combination thereof.

25. The system according to claim 1, wherein said effluent screen is a wedgewire screen.

26. The system according to claim 1, wherein said biological reactor is any one of a tank, basin, lagoon, or any combination of the preceding found within a municipal wastewater treatment facility, an industrial wastewater treatment facility, a commercial wastewater treatment facility, a ship wastewater treatment facility, an agricultural wastewater treatment facility, or any combination thereof.

27. A computer system for regulating the flow of matter to at least one sparge apparatus in a biological reactor or portion thereof, comprising:
a sensor component configured to identify the fluid level in the biological reactor or portion thereof and to communicate said fluid level; and
a controller component configured to receive said fluid level; compare said fluid level to predetermined data points, predetermined data ranges, or a combination thereof; and regulate the flow of matter to at least one sparge apparatus accordingly.

28. A kit for a wastewater treatment facility, comprising:
at least one conduit;
at least one opening located on said at least one conduit;
at least one control point capable of being arranged so as to be in communication with said at least one conduit; and
at least one effluent assembly having an effluent screen;
wherein said at least one effluent assembly is capable of being associated with an effluent penetration point;
wherein said at least one conduit is capable of being affixed at any of in-line with said at least one effluent assembly and below said at least one effluent assembly, inside of said at least one effluent assembly, outside of at least one effluent assembly or any combination thereof and
wherein said at least one opening is capable of being arranged to direct matter in any one pre-selected direction.

29. The kit according to claim 28, further comprising a matter source.

30. The kit according to claim 28, further comprising at least one sensor.

31. The kit according to claim 28, further comprising at least one controller, wherein said controller is capable of being in communication with an at least one sensor, said at least one conduit, said at least one control point, or any combination thereof.

32. The system according to claim 28, wherein said effluent screen is a wedgewire screen, a round wire screen, a perforated screen, an expanded metal screen, or any combination thereof.

33. The kit according to claim 28, wherein said effluent screen is a wedgewire screen.
